(19) United States
(12) Patent Application Publication
(10) Pub. No.: US 2024/0091090 A1
(43) Pub. Date: Mar. 21, 2024

(54) Native American Burial Shroud Device

(71) Applicant: Anthony Begay, Gallup, NM (US)

(72) Inventor: Anthony Begay, Gallup, NM (US)

(21) Appl. No.: 18/468,792

(22) Filed: Sep. 18, 2023

Related U.S. Application Data
(60) Provisional application No. 63/408,612, filed on Sep. 21, 2022.

(51) Int. Cl. A61G 17/06; A61G 17/04

(52) U.S. Cl. CPC A61G 17/06; A61G 17/041

(57) ABSTRACT

A burial shroud device designed to provide a stable and safe base for a body during transport and burial. The device includes a backboard with integrated handles for secure handling, a cushion cover with nylon straps and D-style rings to secure the body, and a shroud fabric for wrapping the body and belongings in a conventional and respectful manner. The device provides a stable and safe base for the body, preventing lateral and sideways movement, while also allowing for easy wrapping of the body and belongings. The shroud fabric comes in different designs, colors, and sizes, allowing for customization to meet the needs and preferences of the user.

### CROSS-REFERENCE TO RELATED APPLICATION

The present application claims priority to, and the benefit of, U.S. Provisional Application No. 63/408,612, which was filed on Sep. 21, 2022 and is incorporated herein by reference in its entirety.

### FIELD OF THE INVENTION

The present invention generally relates to the field of burial shrouds. More specifically, the present invention relates to a novel burial shroud for performing a native American burial. The burial shroud of the present invention has a backboard for supporting a deceased body, a plurality of straps for securing the body, and a shroud for covering the body. A plurality of handles are positioned for pallbearers to easily lift and carry the body without risk of accidental fall. Accordingly, the present disclosure makes specific reference thereto. Nonetheless, it is to be appreciated that aspects of the present invention are also equally applicable to other like applications, devices, and methods of manufacture.

### BACKGROUND

By way of background, a burial shroud is a cloth or garment used for wrapping a deceased person's body for burial and is used as an alternative to a casket. While the use of a casket is common in many cultures, some cultures, including Native American communities, have a tradition of using a burial shroud. The types of burial shrouds used in different cultures depend on the specifics of community and culture. In some communities, a simple white linen cloth is used, while in other cases, a special shroud made from a specific type of cloth or fabric can be used. In Native American communities, regular blankets are commonly used as the shroud. Burial shrouds are often seen as a way to honor the deceased and to show respect for the natural cycle of life and death.

One of the major challenges of using a convention blanket or clothing as a burial shroud is that it can be difficult to handle the body without risking dropping it. Blankets by their design are not rigid and stable and are not designed to hold the weight of a body. Further, the conventional burial shrouds can slip or slide during the burial process. Pallbearers face immense problems in safely lifting and handling conventional burial shrouds.

Another challenge with standard burial shrouds is that they are unable to accommodate other items that are traditionally placed in the ground with the deceased, such as ceremonial objects or offerings. Pallbearers are required to separately carry such items and often, such items are forgotten during the burial process. People desire an improved burial shroud device that can accommodate ceremonial belongings.

Therefore, there exists a long felt need in the art for an improved burial shroud device. There is also a long felt need in the art for a burial shroud device that is safe and easy for carrying a deceased body without risk of accidentally dropping the body. Additionally, there is a long felt need in the art for a native American burial shroud that replaces conventional blankets and other clothing. Moreover, there is a long felt need in the art for an improved burial shroud that is easy to lift and handle for pallbearers. Further, there is a long felt need in the art for a native American burial shroud device that can accommodate other ceremonial objects or offerings. Furthermore, there is a long felt need in the art for a burial shroud device that includes straps with handles for pallbearers to carry the body with minimal risk of accidental fall or accidental slip. Finally, there is a long felt need in the art for a native American burial shroud that keeps the body safe and secure enabling people to honor the deceased.

The subject matter disclosed and claimed herein, in one embodiment thereof, comprises a Native American burial shroud device. The burial shroud device features a sturdy and human shaped backboard having a top surface and bottom surface, the backboard having a top edge, a bottom edge, a pair of upper tapered edges extending from the opposing ends of the top edge, and a pair of lower tapered edges extending from the opposing ends of the bottom edge, a fitted fabric sewn along the edges of the backboard and covering a portion of the top surface and the bottom surface of the backboard, a shroud fabric designed and dimensioned to wrap around the top surface of the backboard when a body lies down on the top surface of the backboard in a supine position, wherein an edge of the shroud fabric is attached to the fitted fabric, a detachably attached cushion cover designed and dimensioned to cover the top surface of the backboard, and four nylon straps for securing the body lying on the cushion cover for burial proceedings, wherein each nylon strap having an individual D-ring for securing the strap around the body of a user. The device has a plurality of handles for easy transportation of a body without any accidental fall or accidental slip.

In this manner, the Native American burial shroud device of the present invention accomplishes all of the forgoing objectives and provides users with a blanket, canvas, or cloth burial shroud equipped with a backboard designed to offer security and stability for Native American burial ceremonies. The device can be carried easily by pallbearers to carry the body with minimal risk of accidental drops. The device acts like a body bag accommodating the body and other ceremonial items.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a burial shroud device for safe and stable Native American burial ceremonies. The burial shroud device further comprising a backboard having a top surface and bottom surface, the backboard is ergonomically designed and shaped like a human body in a supine position, the backboard having a top edge, a bottom edge, a pair of upper tapered edges extending from the opposing ends of the top edge, and a pair of lower tapered edges extending from the opposing ends of the bottom edge, a fitted fabric sewn along the edges of the backboard and covering a portion of the top surface and the bottom surface of the backboard, a shroud fabric designed and dimensioned to wrap around the top surface of the backboard when a body lies down on the top surface of the backboard in a supine position, a detachably attached cushion cover designed and dimensioned to cover the top surface of the backboard, and four nylon straps for securing the body lying on the cushion cover for burial proceedings, wherein each nylon strap having an individual D-ring for securing the strap around the body of a user.

In yet another embodiment, the fitted fabric has a zipper fastener along the top edge, the bottom edge, an upper tapered edge, and corresponding lower tapered edge for fastening a free end of the shroud fabric to wrap the backboard and the body in the burial shroud device.

In yet another embodiment, the burial device includes a plurality of handles, the handles being designed and dimensioned to allow for safe and easy transportation of the burial shroud device.

In a further embodiment, the shroud fabric and the fitted fabric are made of water-resistant materials to protect the body from moisture during burial proceedings.

In a further embodiment, the backboard has four pairs of openings disposed therein, wherein each pair of openings is used for passing a nylon strap through them, the cushion cover has a corresponding set of openings for each pair of the four pair of openings disposed in the backboard, wherein each nylon strap passes through a pair of openings of the backboard and corresponding set of openings of the cushion cover to secure the cushion cover on the top surface of the backboard.

In a further embodiment of the present invention, a burial shroud device is disclosed. The burial shroud device includes a backboard having a top surface and a bottom surface, a cushion cover adapted to be positioned on the top surface of the backboard, a first set of openings disposed in the backboard, a second set of openings disposed in the cushion cover, wherein the second set of openings align and correspond to the first set of openings, a plurality of nylon straps passing through the openings of the cushion cover and the openings disposed in the backboard, a plurality of D-style rings for securing the nylon straps, a fitted shroud fabric sewn along the edges of the backboard, a shroud fabric sewn to the fitted shroud fabric and having a free edge allowing the shroud fabric to fasten to the fitted should fabric using a fastener such as a zipper fastener for covering a body accommodated in the burial shroud device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a native American burial shroud of the present invention in accordance with the disclosed architecture;

FIG. 2 illustrates a perspective view of the native American burial shroud of the present invention without the cushion cover in accordance with the disclosed architecture;

FIG. 3 illustrates an isolated view of the cushion cover of the present invention in accordance with the disclosed architecture;

FIG. 4 illustrates a perspective view showing a body placed within the burial shroud device of the present invention along with other items in accordance with the disclosed architecture;

FIG. 5 illustrates a perspective view showing the shroud fabric in a fastened form like a body bag for securing an accommodated body in the burial shroud device in accordance with the disclosed architecture;

FIG. 6 illustrates a bottom perspective view of the burial shroud device of the present invention showing the straps and handles used in the device in accordance with the disclosed architecture; and

FIGS. 7A and 7B illustrate perspective views showing pallbearers lifting and handling the burial shroud device of the present invention using the handles in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved burial shroud device. There is also a long felt need in the art for a burial shroud device that is safe and easy for carrying a deceased body without risk of accidentally dropping the body. Additionally, there is a long felt need in the art for a native American burial shroud that replaces conventional blankets and other clothing. Moreover, there is a long felt need in the art for an improved burial shroud that is easy to lift and handle for pallbearers. Further, there is a long felt need in the art for a native American burial shroud device that can accommodate other ceremonial objects or offerings. Furthermore, there is a long felt need in the art for a burial shroud device that includes straps with handles for pallbearers to carry the body with minimal risk of accidental fall or accidental slip. Finally, there is a long felt need in the art for a native American burial shroud that keeps the body safe and secure enabling people to honor the deceased.

The present invention, in one exemplary embodiment, is a burial shroud device. The burial shroud device includes a backboard having a top surface and a bottom surface, a cushion cover adapted to be positioned on the top surface of the backboard, a first set of openings disposed in the backboard, a second set of openings disposed in the cushion cover, wherein the second set of opening align and correspond to the first set of openings, a plurality of nylon straps passing through the openings of the cushion cover and the openings disposed in the backboard, a plurality of D-style rings for securing the nylon straps, a fitted shroud fabric sewn along the edges of the backboard, a shroud fabric sewn to the fitted shroud fabric and having a free edge allowing the shroud fabric to fasten to the fitted should fabric using a fastener such as a zipper fastener for covering a body accommodated in the burial shroud device.

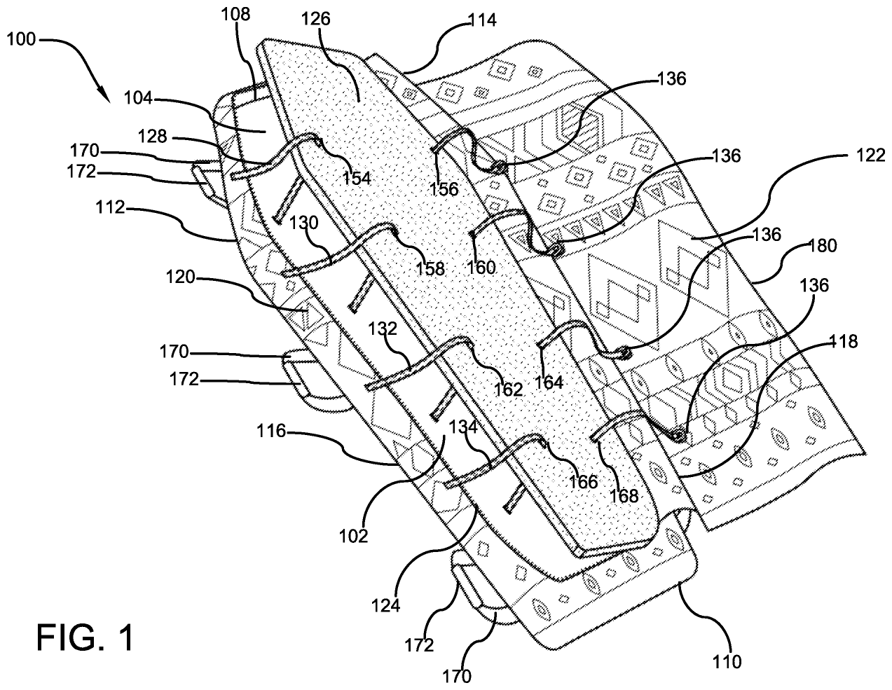

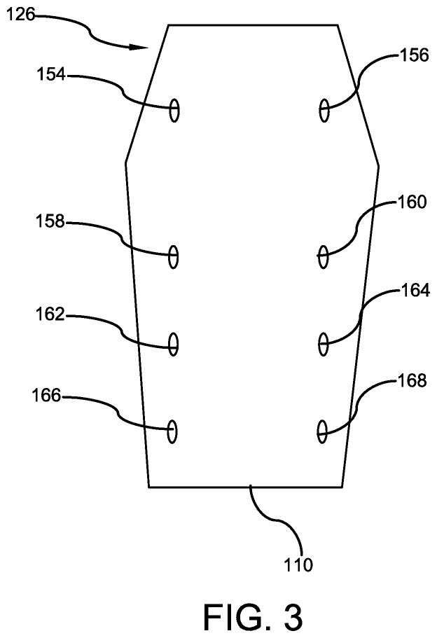

Referring initially to the drawings, FIG. 1 illustrates a perspective view of one potential embodiment of a native American burial shroud of the present invention in accordance with the disclosed architecture. The native American burial shroud 100 of the present invention is designed as an improved burial shroud for safe and stable native American burial ceremonies. The burial shroud 100 is portable, lightweight, and ergonomically designed to carry a person safely. More specifically, the burial shroud 100 has a backboard 102 having a top surface 104 and bottom surface 106 as illustrated in FIGS. 1 and 3.

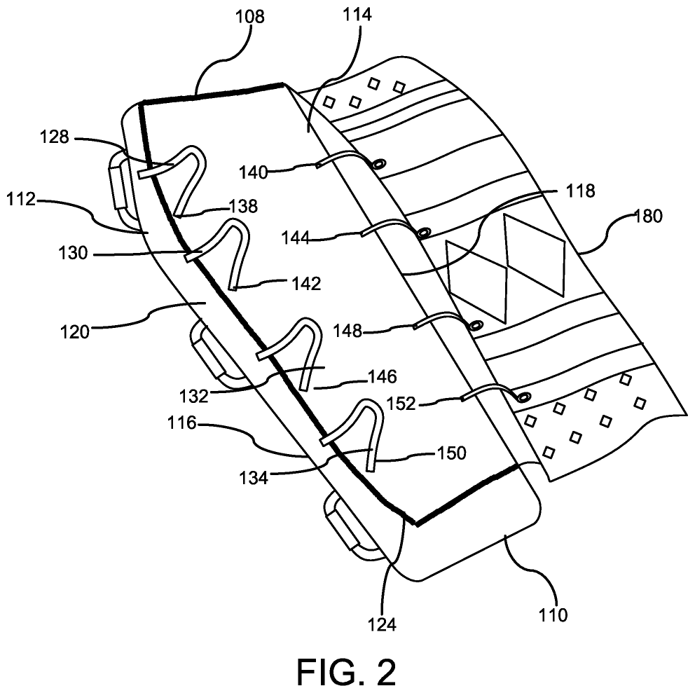

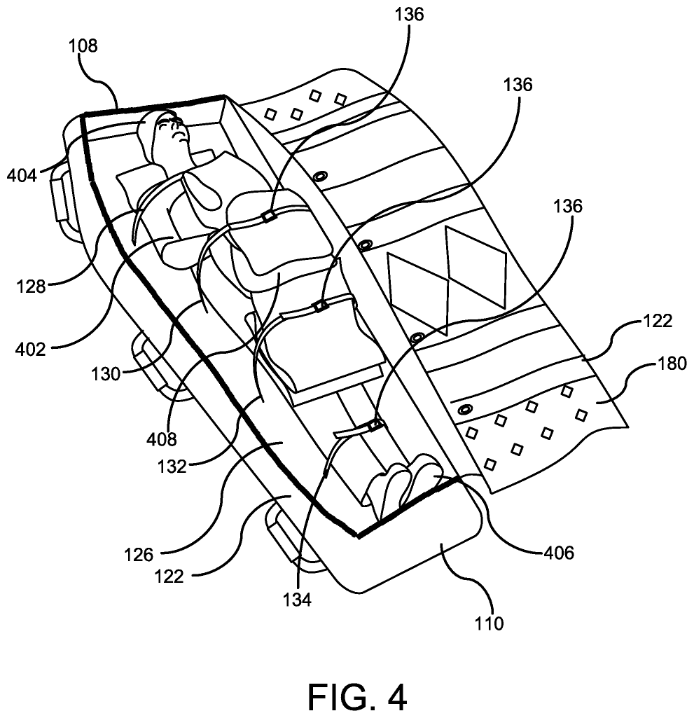

Referring again to FIGS. 1 and 2, the backboard 102 is ergonomically designed to shape like a human body in a supine position and is made from a plywood or molded hard plastic. The backboard 102 has a top edge 108, a bottom edge 110, a pair of upper tapered edges 112, 114 extending from the opposing ends of the top edge 108 and a pair of lower tapered edges 116, 118 extending from the opposing ends of the bottom edge 110 as illustrated in FIG. 2. In use, head of a user is positioned along the top edge 108, and feet of the user are positioned along the bottom edge 110 for a secure and safe positioning of the user as illustrated in FIG. 4.

The backboard 102 has a sewn fabric 120 along the edges thereof for covering a portion of the top surface 104 and the bottom surface 106 as illustrated in FIGS. 1, 2, and 6. The sewn fabric 120 is a conventional blanket or cloth material typically used as a shroud. A shroud fabric 122 is sewn to the fitted fabric 120 along the upper tapered edge 114 and the lower tapered edge 118 of the backboard 102 with the shroud fabric 122 is designed and dimensioned to wrap around the top surface 104 of the backboard 102 when a body lies down on the top surface 104 of the backboard 102 in a supine position as illustrated in FIG. 4.

The fitted fabric 120 has a continuous zipper or fastener 124 along the peripheral edge thereof covering the top edge 108, the bottom edge 110, the upper tapered edge 112, and the lower tapered edge 116. The zipper or fastener 124 is configured to fasten the free edge 180 of the shroud fabric 122 for covering a body positioned in the burial shroud device 100. The shroud fabric 122 along with the fitted fabric 120 functions as a body bag for securing an accommodated body.

The burial shroud 100 has a detachably attached cushioned cover 126 designed and dimensioned to cover the top surface 104 of the backboard 102. The cushion cover 126 can be removed and replaced with a different cover 126 as per requirements of the user. The burial shroud 100 has four nylon straps 128, 130, 132, 134 shown in FIGS. 1, 2, and 4 for securing a body lying on the cover 126 for burial proceedings. Each nylon strap has an individual D-ring 136 for securing the strap around the body of a user as illustrated in FIG. 4.

Referring to FIG. 2, the first nylon strip 128 passes through the openings 138, 140 disposed in the backboard 102. Similarly, the second nylon strip 130 passes through the openings 142, 144 disposed in the backboard 102. The third nylon strip 132 passes through the openings 146, 148 and the fourth nylon strip 134 passes through the openings 150, 152. Each pair of the openings are symmetrical and prohibit the nylon straps from sliding or rolling during use.

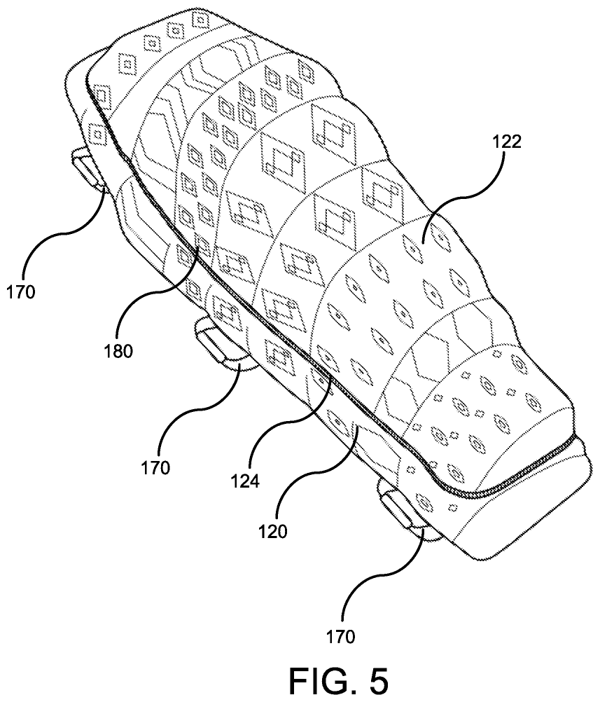

Referring to FIGS. 1 and 3, cushion cover 126 also has a first set of openings 154, 156 corresponding to the openings 138, 140 allowing the first nylon strap 128 to secure the cushioned cover 126 on the top surface 104 of the backboard 102. Similarly, the cushion cover 126 has a second set of openings 158, 160 corresponding to the openings 142, 144, a third set of openings 162, 164 corresponding to the openings 146, 148 and a fourth set of openings 166, 168 corresponding to the openings 150, 152. The nylon straps 128, 130, 132, 134 help in securing the cushion cover 126 on the top surface 104 such that a body can be laid down on the cushion cover 126 as illustrated in FIG. 5. Each strap goes through the corresponding openings of the cushion cover 126 and is secured using the corresponding D-style ring 136 as illustrated in FIG. 4.

For safely handling the native American burial shroud device 100 of the present invention, a plurality of handles 170 are integrated to the bottom surface 106 of the backboard 102. The handles 170 are ergonomic and have grips 172 for secure handling by pallbearers. The handles 170 eliminate the risk of accidentally dropping the burial shroud 100 as often seen in conventional burial shroud devices.

FIG. 4 illustrates a perspective view showing a body placed within the burial shroud device of the present invention along with other items in accordance with the disclosed architecture. As illustrated, a body 402 is placed on the cushion cover 126 when the cushion cover 126 is positioned on the backboard 102 of the device 100. The body 402 is preferably placed in a supine position with a head 404 positioned near the top edge 108 of the backboard 102 and the feet 406 positioned near the bottom edge 110 of the backboard 102.

Belongings 408 of the body 402 are positioned on top of the body 402 in a stable and safe manner. The body 402 is secured using the nylon straps 128, 130, 132, 134 wherein each nylon strap is fastened using the corresponding D-style ring 136. Individual nylon straps are snugly fit to stable the body, thereby preventing the body 402 from rolling or sliding laterally and sideways. The backboard 102 and the cushion cover 126 provide a stable base for the body without any deformation in the burial shroud device 100. The length of the backboard 102 can be designed to meet requirements of keeping bodies of different sizes. It should be noted that shroud fabric 122 allows the body 402 and the belongings 408 to be easily wrapped as illustrated in FIG. 5.

FIG. 5 illustrates a perspective view showing the shroud fabric 122 in a fastened form like a body bag for securing an accommodated body in the burial shroud device in accordance with the disclosed architecture. As illustrated, the free edge of the shroud fabric 122 is fastened to the zipper or fastener 124 of the fitted fabric 120 to completely cover a body of a user position in the burial shroud device 100. The fabric 122 resembles conventional shrouds and blankets and can come in different designs, colors, and sizes.

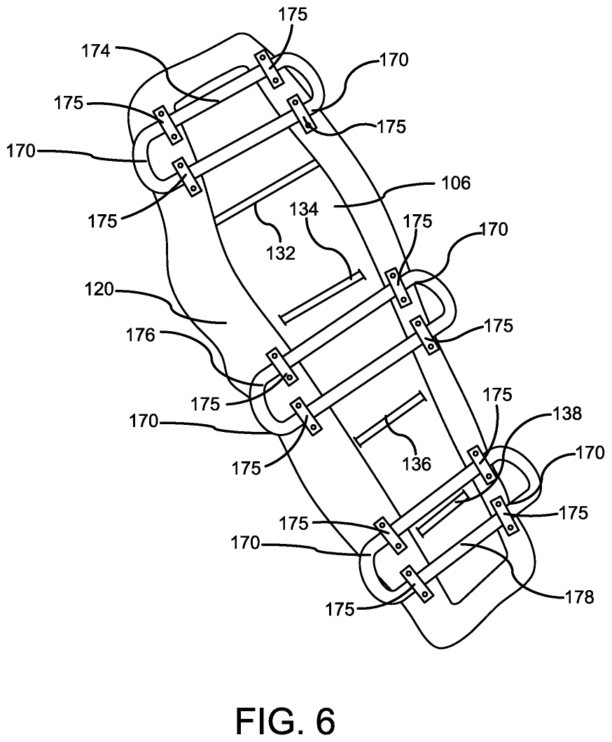

FIG. 6 illustrates a bottom perspective view of the burial shroud device of the present invention showing the straps and handles used in the device in accordance with the disclosed architecture. The fitted shroud fabric 120 covers at least a portion of the bottom surface 106 of the backboard 102. Further, the fitted fabric 120 can be sewn or attached to the backboard 102 for effective positioning of the fitted fabric 120. The device has three handle straps 174, 176, 178 positioned equidistantly along length of the backboard 102. Individual handle straps have the handles 170 on opposing ends and each handle strap forms a closed loop and is fastened using the clip fasteners 175. When the burial shroud 100 is lifted and handled by pallbearers, the handle straps 174, 176, 178 do not slide across the backboard 102 and therefore, provides stability to the burial shroud 100.

Each nylon strap of the plurality of the nylon straps 128, 130, 132, 134 passes through the corresponding openings as described earlier in the disclosure and obviates any slack along the bottom surface 106 of the backboard 102.

Referring back to FIG. 2, the first nylon strip 128 passes through the openings 138, 140. Similarly, the second nylon strip 130 passes through the openings 142, 144 disposed in the backboard 102. The third nylon strip 132 passes through the openings 146, 148 and the fourth nylon strip 134 passes through the openings 150, 152. The free ends of the nylon straps are used for securing a body and belongings as illustrated in FIG. 4.

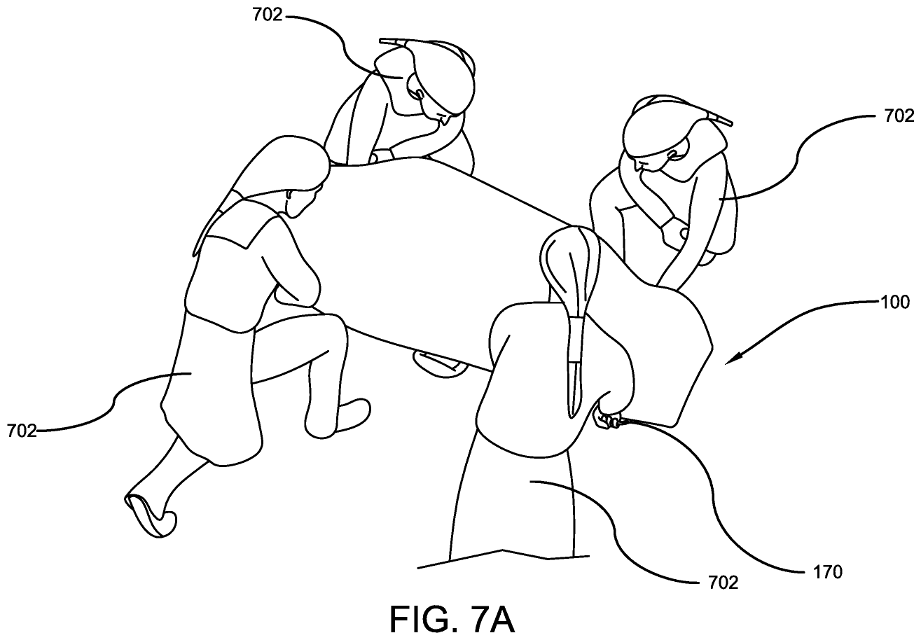

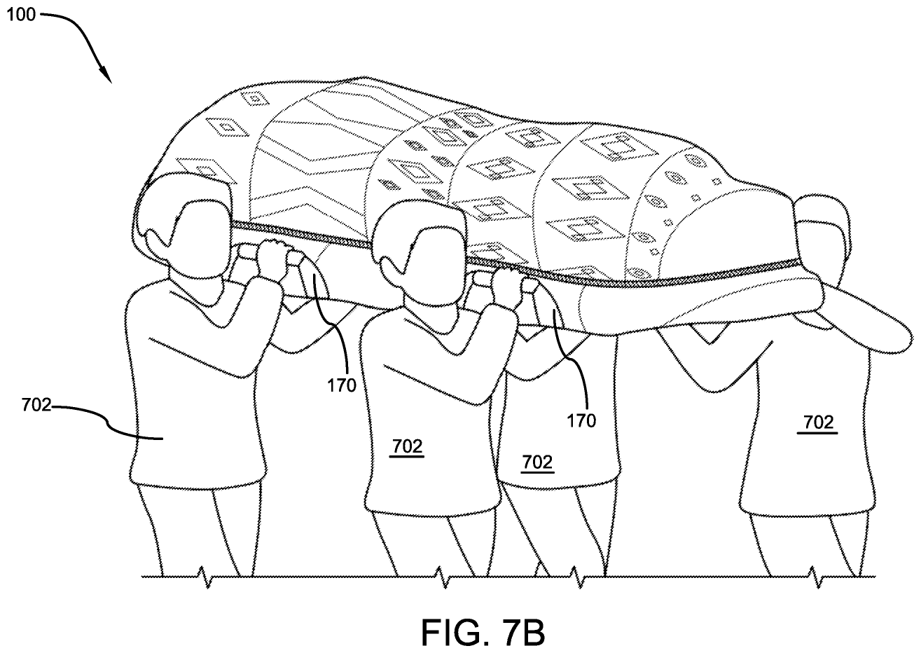

FIGS. 7A and 7B illustrate perspective views showing pallbearers lifting and handling the burial shroud device of the present invention using the handles in accordance with the disclosed architecture. As illustrated, in FIG. 7A, one or more pallbearers 702 can hold the handles 170 for stably and easily lifting the burial shroud device 100. The body 402 is securely positioned in the device 100 and is protected by the shroud fabric 122. The handle straps 174, 176, 178 do not slip during handling of the handles 170.

As illustrated in FIG. 7B, the pallbearers 702 can easily lift and carry the shroud device 100 on shoulders without fear of accidentally dropping the body and the burial shroud 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “burial shroud”, “burial shroud device”, “native American burial shroud”, “shroud device”, and “device” are interchangeable and refer to the native American burial shroud device 100 of the present invention.

Notwithstanding the forgoing, the native American burial shroud device 100 of the present invention can be of any suitable size and configuration as is known in the art without affecting the overall concept of the invention, provided that it accomplishes the above stated objectives. One of ordinary skill in the art will appreciate that the native American burial shroud device 100 as shown in the FIGS. are for illustrative purposes only, and that many other sizes and shapes of the native American burial shroud device 100 are well within the scope of the present disclosure. Although the dimensions of the native American burial shroud device 100 are important design parameters for user convenience, the native American burial shroud device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable burial shroud comprising:
a burial shroud having a backboard with a top surface and a bottom surface for ergonomically carrying a person;
wherein said backboard having a shape of a human body in a supine position including a top edge, a bottom edge, a pair of upper tapered edges extending from opposing ends of said top edge, and a pair of lower tapered edges extending from opposing ends of said bottom edge;
wherein said backboard having a sewn fitted fabric for fitting around said bottom surface, said pair of upper tapered edges, and said pair of lower tapered edges;
a shroud fabric sewn to said fitted fabric along at least one of said pair of upper tapered edges and at least one of said pair of lower tapered edges;
wherein said shroud fabric dimensioned to wrap around and over a body resting on said top surface of said backboard;
wherein the body is laying in a supine position on said top surface of said backboard;
wherein said fitted fabric having a continuous fastener along a peripheral edge thereof for fastening to a free edge of said shroud fabric; and
further wherein said fitted fabric and said shroud fabric forming a body bag for securing the body therein.

2. The portable burial shroud of claim 1, wherein said burial shroud further including a selectively attached cushion dimensioned to cover said top surface of said backboard.

3. The portable burial shroud of claim 2 further comprising a plurality of straps for securing the body lying on said cushion.

4. The portable burial shroud of claim 3, wherein each of said plurality of straps extending through an associated pair of openings in said backboard.

5. The portable burial shroud of claim 4, wherein each of said plurality of straps having a D-ring for securing each of said plurality of straps around the body.

6. The portable burial shroud of claim 5, wherein said backboard having a material selected from a plywood and a molded hard plastic.

7. The portable burial shroud of claim 5, wherein each of said plurality of straps extending through an associated pair of openings in said cushion.

8. The portable burial shroud of claim 7, wherein each said pair of openings in said backboard align with a corresponding said pair of openings in said cushion.

9. The portable burial shroud of claim 7, wherein said backboard having a plurality of handles for carrying said burial shroud by a plurality of users.

10. The portable burial shroud of claim 9, wherein said plurality of handles include at least two handles on each side of said backboard.

11. The portable burial shroud of claim 10, wherein said fitted fabric attached to said bottom surface of said backboard.

12. The portable burial shroud of claim 10, wherein each pair of opposing handles having a handle strap connecting said each pair of opposing handles, and further wherein each of said handle strap extending across said bottom surface of said backboard.

13. A portable burial shroud comprising:
a burial shroud having a backboard with a top surface and a bottom surface for ergonomically carrying a person;
wherein said backboard having a shape of a human body in a supine position including a top edge, a bottom edge, a pair of upper tapered edges extending from opposing ends of said top edge, and a pair of lower tapered edges extending from opposing ends of said bottom edge;
wherein said backboard having a sewn fitted fabric for fitting around said bottom surface, said pair of upper tapered edges, and said pair of lower tapered edges;
a shroud fabric sewn to said fitted fabric along at least one of said pair of upper tapered edges and at least one of said pair of lower tapered edges;
wherein said shroud fabric dimensioned to wrap around and over a body resting on said top surface of said backboard;
wherein the body is laying in a supine position on said top surface of said backboard;
wherein said fitted fabric having a continuous fastener along a peripheral edge thereof for fastening to a free edge of said shroud fabric;
wherein said fitted fabric and said shroud fabric forming a body bag for securing the body therein;
a plurality of straps for securing the body lying on said backboard; and
further wherein each of said plurality of straps extending through an associated pair of openings in said backboard.

14. The portable burial shroud of claim 13, wherein each of said plurality of straps having a D-ring for securing each of said plurality of straps around the body.

15. The portable burial shroud of claim 14, wherein said backboard having a plurality of handles for carrying said burial shroud by a plurality of users.

16. The portable burial shroud of claim 15, wherein said plurality of handles include at least two handles on each side of said backboard.

17. A portable burial shroud comprising:
a burial shroud having a backboard with a top surface and a bottom surface for ergonomically carrying a person;
wherein said backboard having a shape of a human body in a supine position including a top edge, a bottom edge, a pair of upper tapered edges extending from opposing ends of said top edge, and a pair of lower tapered edges extending from opposing ends of said bottom edge;
wherein said backboard having a sewn fitted fabric for fitting around said bottom surface, said pair of upper tapered edges, and said pair of lower tapered edges;
a shroud fabric sewn to said fitted fabric along at least one of said pair of upper tapered edges and at least one of said pair of lower tapered edges;
wherein said shroud fabric dimensioned to wrap around and over a body resting on said top surface of said backboard;
wherein the body is laying in a supine position on said top surface of said backboard;
wherein said fitted fabric having a continuous fastener along a peripheral edge thereof for fastening to a free edge of said shroud fabric;
wherein said fitted fabric and said shroud fabric forming a body bag for securing the body therein;
a plurality of straps for securing the body lying on said backboard;
wherein each of said plurality of straps extending through an associated pair of openings in said backboard;
wherein said backboard having a plurality of handles for carrying said burial shroud by a plurality of users; and
further wherein said plurality of handles include at least three handles on each side of said backboard.

18. The portable burial shroud of claim 17, wherein each of said plurality of straps having a D-ring for securing each of said plurality of straps around the body.

19. The portable burial shroud of claim 18, wherein said fitted fabric attached to said bottom surface of said backboard.

20. The portable burial shroud of claim 19, wherein each pair of opposing handles having a handle strap connecting said each pair of opposing handles, and further wherein each of said handle strap extending across said bottom surface of said backboard.
